(19) United States
(12) Patent Application Publication
(10) Pub. No.: US 2021/0247881 A1
(43) Pub. Date: Aug. 12, 2021

(54) INTEGRATED AND INTERACTIVE REGULATORY COMPLIANCE

(71) Applicant: PRIVATE ADVISOR GROUP LLC, Morristown, NJ (US)

(72) Inventors: Petra BARONE, Morristown, NJ (US); Sean SULLIVAN, Verona, NJ (US); Patrick SULLIVAN, Morristown, NJ (US); Kevin SULLIVAN, Chatham Township, NJ (US); James PERHACS, Long Valley, NJ (US); James HOOKS, Fort Mill, SC (US); Julie GALBRAITH, Highland Lakes, NJ (US); James SULLIVAN, New Rochelle, NY (US)

(21) Appl. No.: 16/783,921

(22) Filed: Feb. 6, 2020

(51) Int. Cl. G06F 3/0484; G06F 16/23; G06Q 10/10; G06Q 30/00; G06Q 10/06; G06F 3/0482; H04L 12/24

(52) U.S. Cl. CPC G06F 3/0484; G06F 16/2379; G06Q 10/105; H04L 41/22; G06Q 10/063114; G06F 3/0482; H04L 41/5019; G06Q 30/018

(57) ABSTRACT

Bi-directional communication, through a computing system, may be used to maintain and monitor regulatory compliance. Employees of a firm may be prompted to provide information, which may be communicated to the computing system and stored in one or more databases. An internal auditor may be provided with a user interface that permits the initiation of audits, viewing of information reported, and/or the opportunity to provide findings and/or comments based on the information reported. The information reported may be provided to the auditor in the form of predetermined types of reports, based on the information reported.

### FIELD

Various aspects of the present disclosure may relate to systems and/or processes for integrated handling of various types and/or aspects of regulatory compliance.

### BACKGROUND

Firms operating in many industries, for example, the financial industry, are often subject to various forms of regulation. A regulatory body is a person, organization or government agency that addresses regulatory compliance. Regulatory bodies may include a federal government (or agency thereof), one or more state or provincial governments (or agencies thereof), local governments (or agencies thereof), professional organizations, etc. Regulations may take the form of statutory regulations, administrative regulations and/or standards that an industry organization sets and maintains. A firm may be required to submit various reports and/or to make various disclosures and/or representations to regulatory bodies in order to show compliance with regulations.

In order to do so, or additionally, a firm may require internal review of the same and/or further information, e.g., for supervisory/internal auditing purposes, as well as to prepare submissions to various regulatory bodies. In order to enable this, the firm may require that employees submit the necessary information. This may be, e.g., on a periodic basis. The information may then be reviewed by supervisors and/or internal auditors (to be collectively referred to as “internal auditors”), who may have the job within the firm of establishing and maintaining regulatory compliance and providing reports to regulatory bodies.

To perform such tasks, much information may need to flow between employees and internal auditors. It would be desirable to establish a communication and computing system in which the data flows are organized and efficient and in which the amount of effort required to maintain regulatory compliance is minimized.

### SUMMARY OF VARIOUS ASPECTS OF THE DISCLOSURE

Various aspects of the present disclosure may relate to ways in which the above issues may be addressed. In particular, bi-directional communication, through a computing system, may be used to maintain and monitor regulatory compliance. Employees of a firm may be prompted to provide information, which may be communicated to and stored in one or more databases. An internal auditor may be provided with a user interface that permits the initiation of audits, viewing of information reported, which may be presented in the form of predetermined types of reports, and/or the opportunity to provide findings and/or comments to those responding to the audits.

Implementations may be in the form of hardware, software, firmware, or combinations thereof, including executable instructions stored on a non-transitory computer-readable medium, e.g., a memory device, that may be executed on one or more processing devices. Various components may be implemented in one or more chips, chipsets, circuit boards, etc., or in the form of one or more programmed processors.

### BRIEF DESCRIPTION OF THE DRAWINGS

Various aspects of the disclosure will now be described in conjunction with the accompanying drawings, in which:

FIG. 1 shows a conceptual diagram of an example of a system according to various aspects of the present disclosure;

FIG. 2 shows a conceptual diagram of an example of a subsystem of a system according to various aspects of the present disclosure;

FIGS. 3 and 4 show conceptual flow diagrams of examples of processes that may be carried out according to various aspects of the present disclosure;

FIGS. 5 and 6 show further conceptual flow diagrams of examples of processes that may be carried out according to various aspects of the present disclosure; and

FIGS. 7-10 show conceptual examples of user interfaces that may be provided according to various aspects of the present disclosure.

### DETAILED DESCRIPTION OF VARIOUS ASPECTS OF THE DISCLOSURE

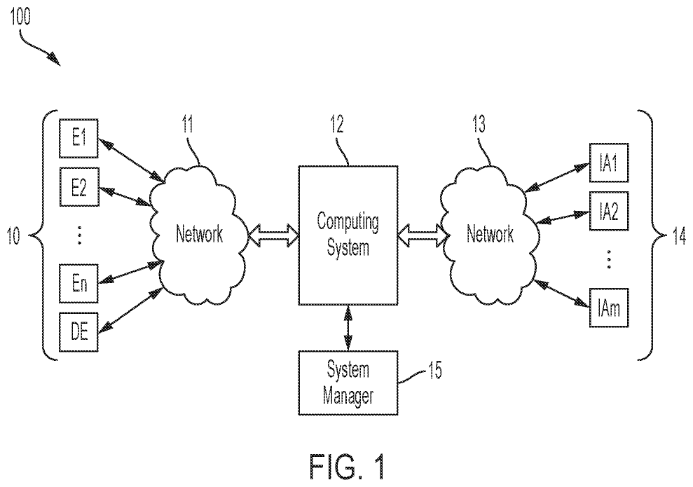

FIG. 1 shows an example of a system 100 according to various aspects of the present disclosure. Employees 10 (individually labeled E1, E2, . . . , En, DE) using various computing and/or communication devices (e.g., but not limited to desktop computers, laptop computers, tablet computers, smartphones, etc.) may be connected via a first communication network 11 to a computing system 12. Similarly, internal auditors 14 (individually labeled IA1, IA2, . . . , IAm), also using various computing and/or communication devices (which may or may not be the same types of devices used by the employees) are connected to computing system 12 via second communication network 13. Communication network 11 and communication network 13 may be distinct networks or may be the same network. One or both may correspond to the Internet, one or more proprietary networks, one or more local area networks (LANs), one or more wide area networks (WANs), or one or more other types of networks. Additionally, or alternatively, some devices may have direct “hard-wired” connections to the computing system 12, and such a scenario is also included in the general term, “communication network” (i.e., such a scenario may be characterized as a “point-to-point network”). In one sense, one may consider computing system 12 to serve as a hub in a hub-and-spokes type of communication system. The computing system may be operated under the supervision of a system manager 15.

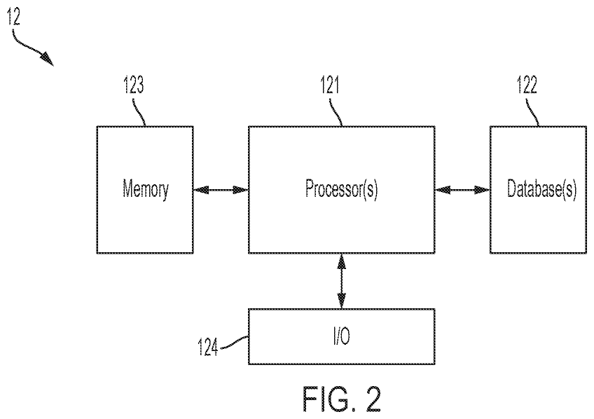

FIG. 2 shows an example of computing system 12, showing various examples of components that may be included therein. Computing system 12 may include one or more processors 121. The one or more processors 121 may be communicatively coupled to one or more databases 122 and memory 123. Memory 123 may include any type of memory, e.g., but not limited to, random-access memory (RAM), read-only memory (ROM), disk memory, flash memory, magnetic memory (e.g., tape), etc. The one or more databases 122 may be implemented in any type of memory that may be written to and read from and may be used to store and retrieve user data, such as, but not limited to, personal data and/or compliance-related data. Memory 123 may be non-transitory and may store instructions that result in the implementation of various operations; such instructions may include an operating system, basic input/output system (BIOS), and/or instructions implementing operations relating to regulatory compliance-related techniques. Computing system 12 may also include input/output (I/O) systems 124, which may include, for example, but are not limited to, visual display(s), touch-screen display(s), a keyboard, a mouse, a trackball, a joystick, a touchpad, communication network interface(s) (which may include transmitters, receivers, antennas, waveguides, amplifiers, modulators, demodulators, modems, and/or other communication components, as well as associated control and/or internal communication components (e.g., processor(s), memory, bus structures, etc.)). System manager 15 may communicate with computing system 12 via I/O systems 124.

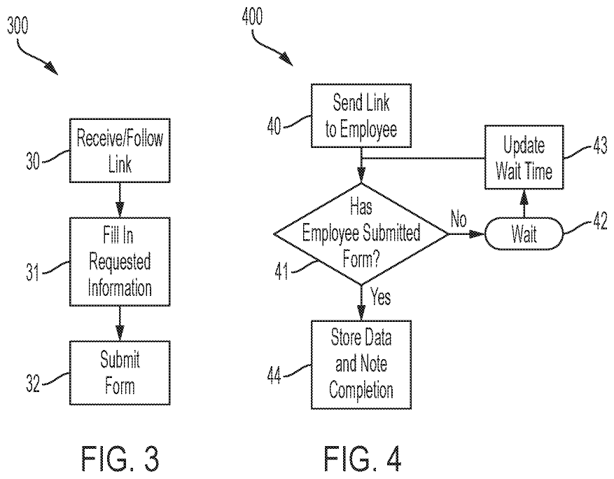

FIGS. 3 and 4 show conceptual flow diagrams of processes that may be executed on the employee-side of system 100, according to various aspects of the present disclosure. One or more of employees 10 may be sent 40, by computing system 12, via communication network 11, prompts to provide information. A prompt may take the form of a link that, when selected (e.g., but not limited to, by clicking on the link with a mouse, by tapping on the link on a touchscreen, or the like) 30, directs the computing/communication device being used by the employee 10 who received the link to display a questionnaire or other information request hosted by the computing system 12, for the employee 10 to fill in/provide information in response. This questionnaire or other information request may take the form of a webpage but is not limited thereto. The computing system 12 may determine 41, e.g., at intervals of time, whether a given employee 10 has yet filled in 31 and submitted 32 the requested information. If not, the computing system may wait 42 for some interval of time and then may update a wait time 43 for the given employee 10 and once again determine 41 whether that employee 10 has submitted 32 the requested information. Once the employee 10 has submitted 32 the requested information, the requested information may be stored, e.g., in database(s) 122, and the fact that the employee has submitted in the information may be recorded 44. A particular time of completion (time and/or date) may be recorded for each employee when the information has been provided.

According to some aspects of the present disclosure, when an information request/questionnaire is provided to an employee 10, information from that employee's previous response (e.g., during a previous reporting period) may be displayed. This may, for example, permit the employee 10 to update only information requiring updating, rather than entering all information, and may also provide the employee 10 with baseline information that may be helpful to the employee 10 for entering new information.

In the specific example of financial compliance auditing and reporting, the information requested and provided may include, for example, but is not limited to, account information, trading activities, non-cash compensation, business continuity plans (BCPs), etc. In other industries, the information requested and provided may differ. For examples, in some industries, the information requested and provide may relate to continuing education, client/customer/patient information, pro bono activity, et al.

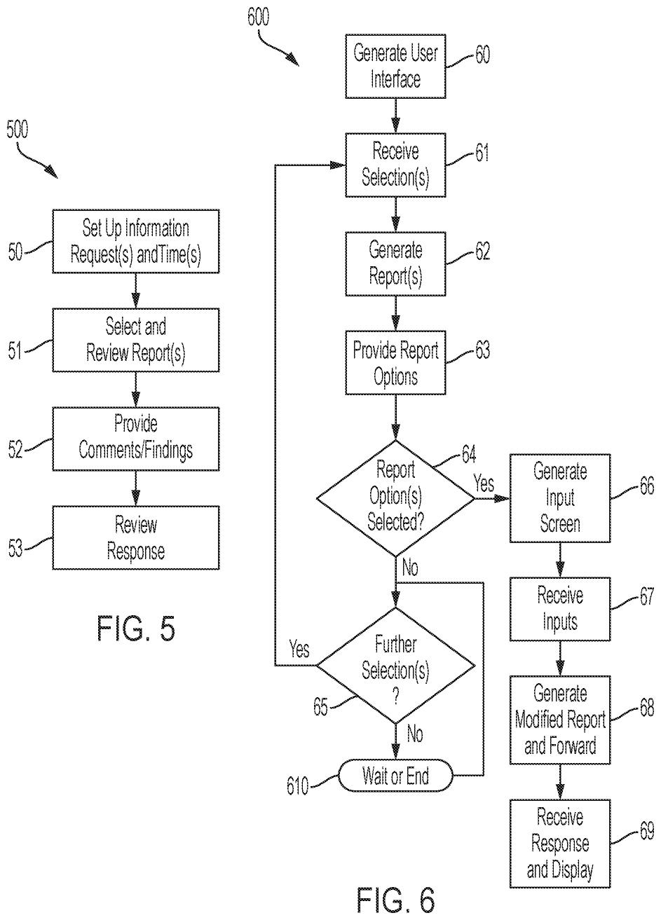

FIGS. 5 and 6 show conceptual flow diagrams of processes 500, 600 that may be executed on the internal auditor side of system 100, according to various aspects of the present disclosure. Information requests and times for their distribution and/or completion may be set up 50. This may be done by an internal auditor 14 providing information to system manager 15 to enter into computing system 12 to prepare a new information request/questionnaire or modify a previous one. The system manager 15 may further enter dates on which the information requests should be “pushed out” to the employees 10 and/or due dates for completion of the information requests. Some information requests may be set up as periodic requests, to be sent out and returned on a periodic basis, such as, but not limited to, weekly, monthly, quarterly, biannually, or annually. The processes regarding providing the information requests and receiving responses have been discussed above, in connection with FIGS. 3 and 4, and will not be repeated here; the remainder of this discussion about the internal auditor side will focus on the interactions between the computing system 12 and the internal auditor(s) 14, once the process of providing information requests has begun.

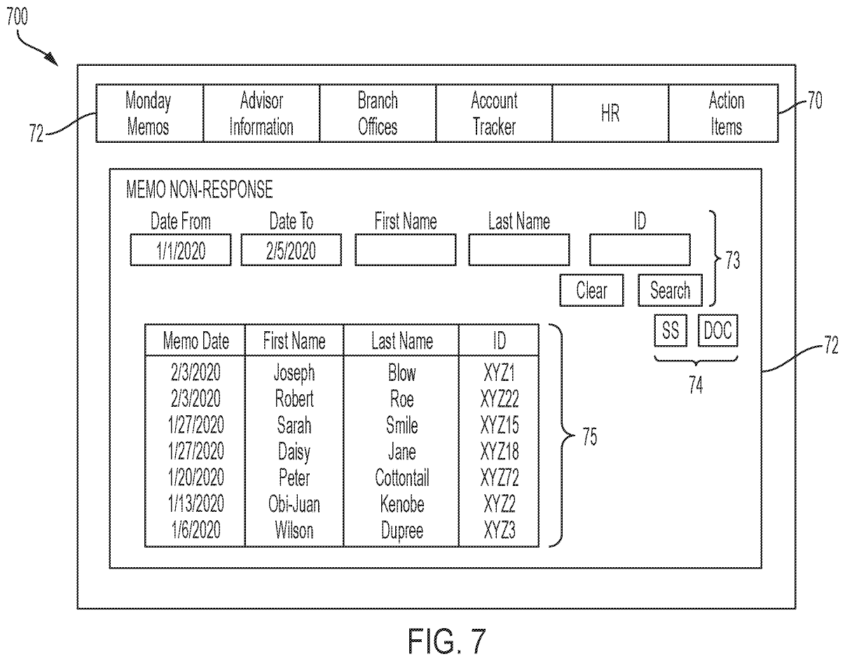

Computing system 12 may generate 60 an interactive graphical user interface for an internal auditor 14. Further details of the graphical user interface will be discussed below, in conjunction with FIGS. 7-9. The graphical user interface may permit the internal auditor 14 to select and review 51 one or more reports. The computing system 12 may receive 61 one or more selection(s) selected 51 by the internal auditor 14 and may automatically generate 62 one or more reports associated with the one or more selections made by the internal auditor 14; such reports may be based on information collected from employees 10. The internal auditor 14 may then review 51 the one or more reports. These reports may be shown in an interactive graphical user interface, in which options may be provided 63. Options may include search options, download options, action options, etc., as will be discussed further below. Computing system 12 may determine 64 whether the internal auditor 14 has selected any report option(s). If not, computing system 12 simply awaits further selections 65 from the internal auditor 14, and if none are received, the process 600 may continue to wait (and may loop back, as shown) or end (e.g., after a timeout period) 610. If one or more further selections are made, the process may loop back to block 61.

Options provided to the internal auditor 14 may include providing comments and/or findings based on a report; this is the only option addressed in FIGS. 5 and 6, although other options may be presented to the internal auditor 14. Should a selection of a report option be made by internal auditor 14 and detected 64 by computing system 12, and again, should that option be to provide comments or findings, an input screen may be generated and presented 66 to the internal auditor 14, who may then enter her comments and/or findings 52, which may be received 67 by computing system 12. The internal auditor 14 may be reviewing the reports for regulatory compliance-related matters, and for example, the findings may relate to the internal auditor's findings regarding regulatory compliance.

Once the internal auditor 14 has entered 52 her comments/findings, computing system 12 may automatically generate 68 a modified report, including the comments/findings. The modified report may be forwarded 68 to a designated employee DE. As a particular example, employees 10 may be associated with a particular office of a firm or group within a firm, and one of the employees 10 may be made the designated employee DE for the purposes of addressing regulatory compliance issues for that office or that group of employees.

The modified report may be provided in the form of a link, and the designated employee DE may follow a process similar to that of FIG. 3 to follow the link, and the report may be presented by computer system 12 in the form a of graphical user interface with field in which the designated employee DE may enter responsive information. As an alternative, the modified report may be provided in another format (e.g., as a spreadsheet, as a document, etc.) with the comments/findings of the internal auditor included, and a link may be provided to a response graphical user interface for the designated employee to enter a response.

Once a response has been received 69 by computing system 12, it may be made available for display 69 to the internal auditor 14 for her review 53. There are a number of ways in which this may be implemented. The response may be integrated into the report, or the response may be kept separate from the report, by computing system 12. Computing system 12 may provide a notification to the internal auditor 14 that a response has been entered and is ready for review; this may be performed, e.g., by sending to the internal auditor 14 an automatically generated e-mail, text message, phone message, on-screen notification in the graphical user interface, or other type of notification. Alternatively, when a response is received 69, computing system 12 may automatically display 69 the response, which may be integrated into the report or presented with or as part of the report, at least for display purposes. The internal auditor may then review the response 53 and may take appropriate action.

FIG. 7 shows an example of a graphical user interface (GUI) 700 display that may be displayed to an internal auditor 14, according to various aspects of the present disclosure. The graphical user interface may include a first set of selectable options 70, shown in FIG. 7 as a solid bar, but not thus limited. The selectable options 70 may, when selected, provide drop-down menus of choices that may result in various displays with various functions and/or options. When a given selectable option 70 is selected, e.g., “Monday Memos” 72, that option may be shaded, provided with a different color from the other selectable options 70, or the like, which may indicate its selection. A given selectable option, such as “Monday Memos” 72, may, if selected, result in a default report display, or it may simply leave whatever report was previously being displayed on the screen until a selection is made from the drop-down menu (it is noted that it is also possible for a given selectable option 70 not to have a drop-down menu and to simply display whatever report is associated with that selectable option). In the example of graphical user interface 700, a MEMO NON-RESPONSE display 72 is shown. This may provide a listing 75 of employees who have not yet responded to one or more information requests. Display 72 may further include a search area 73 that provides various fields on which a search may be performed and buttons to clear the fields or execute the search. Display 72 may further provide buttons 74 that, if selected, may produce a copy of the report in various forms, e.g., a spreadsheet (e.g., in Microsoft® Excel® format) or a document (e.g., in a portable document format (PDF) document).

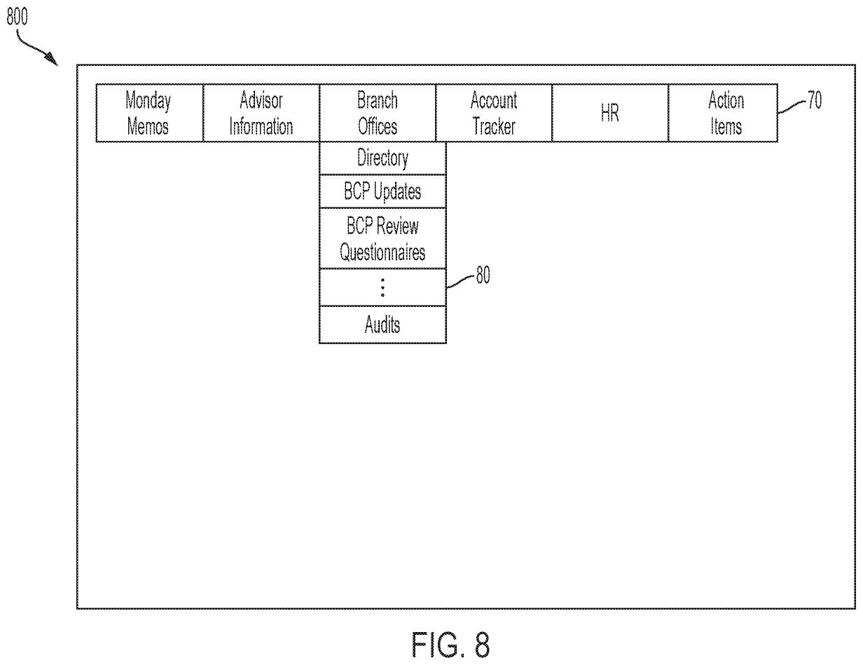

FIG. 8 shows a second example of a graphical user interface 800 display that may be displayed to an internal auditor 14, according to various aspects of the present disclosure. As was previously noted, when a selectable option 70 is selected, a drop-down menu 80 may be displayed. In the example of graphical user interface 800, “Branch Offices” has been selected, and so a drop-down menu 80 that pertains to reports and/or other actions relating to branch offices may be displayed. Examples of selections within the drop-down menu 80 may include a directory, business continuation plan (BCP) updates, BCP review questionnaires, BCP testing, BCP approvals, audits, etc. When one of these is selected, an associated display may be presented to the internal auditor 14, and the associated display may include various types of information, permit searches, allow initiation of audits, initiated information requests, or the like.

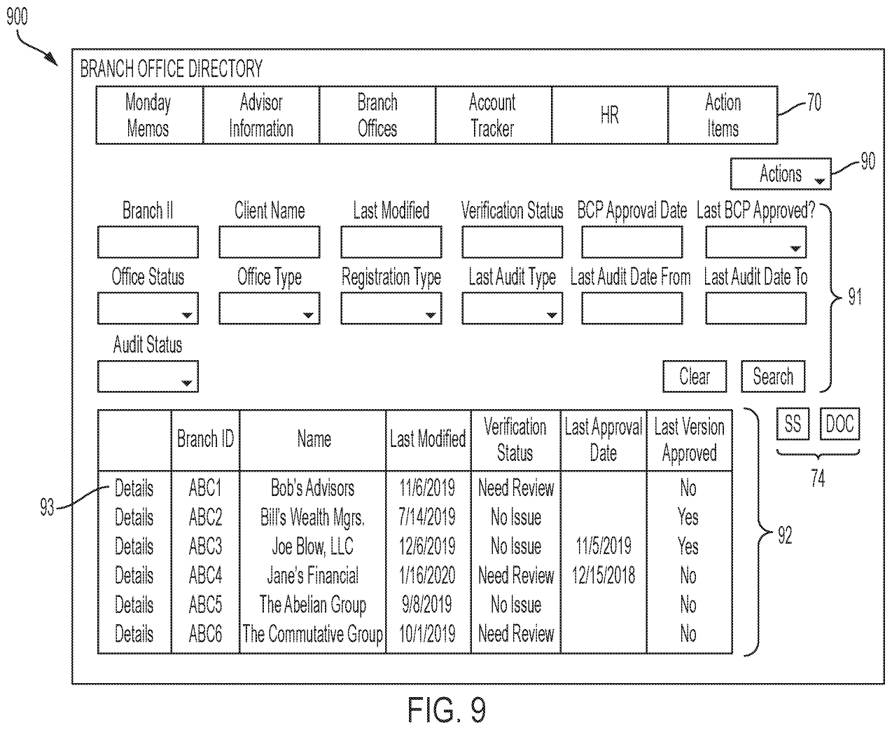

As an example, FIG. 9 shows a graphical user interface 900 display that may be displayed when Directory is chosen from the drop-down menu 80 of FIG. 8, according to various aspects of this disclosure. The selectable options 70 may remain in the graphical user interface 900, which may permit the internal auditor 14 to move among different types of functions, reports, etc. A search area 91 may be provided, which may permit internal auditor 14 to search the branch office directory to find one or more branch offices of interest. Report generation buttons 74 may also be provided, and a display 92 of branch offices may also be shown, in some default order. An order of display may be selected by the internal auditor based on one or more of the field headings in the display 92. Also included in the graphical user interface 900 is an actions button 90. If selected, the actions button 90 may provide a drop-down menu of various actions that may be taken. Examples of such actions may include, but are not limited to, adding a new branch office, exporting documents, initiating information requests (e.g., BCP questionnaires), et al. In the case in which “Audits” is chosen from drop-down menu 80 (display not shown), the actions may include, for example, initiating an audit.

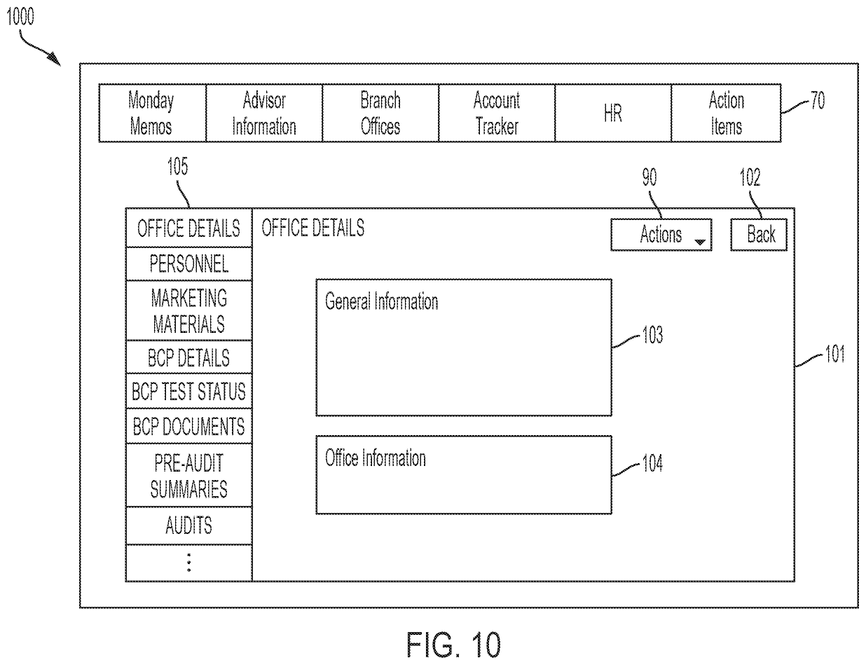

In addition to the selectable options 70 shown in FIGS. 7-9, a display 92, such as shown in FIG. 9, may include a “Details” button 93 next to each entry in the display. If the internal auditor 14 selects a Details button 93, further details regarding the entry (in the case of display 92, branch office) may be displayed. An example of a graphical user interface 1000 display that may be displayed for a given branch office for which the “Details” button 93 has been selected is shown in FIG. 10. The initial “Office Details” display 101 may provide general information 103 and/or more specific office information 104. An Actions button 90 may be provided, which may cause various action options (e.g., mark office as inactive, send BCP questionnaire, etc.) to be offered, as well as a back button 102, to return to the previous screen 900. Display 101 may also include other selectable options 105 to obtain further details about the specific branch office. An active one of the selectable options 105 may be highlighted, colored differently from the other selectable options, etc., to indicate to the internal auditor 14 that this is the display being shown. As noted, other selectable options 105 under Office Details may include a list of personnel at the office, marketing materials, BCP-related displays, audit-related displays, etc. Documents and other materials may be stored electronically in the database 122.

Computing system 12 may also automatedly, or semi-automatedly, generate reports to be provided to regulatory bodies. In the financial industry, such regulatory bodies may include the U.S. Securities and Exchange Commission (SEC), the U.S. Financial Industry Regulatory Agency (FINRA), et al. Generation of such reports may be performed by computing system 12 upon request by an internal auditor 14 (who may be the firm's Chief Compliance Officer (CCO)). The CCO may request a computer-generated report, review it for accuracy, approve it (which may be in the form of an electronic or physical signature, depending upon reporting requirements), and arrange for forwarding to the relevant regulatory body. In a case in which electronic signature may be used, the computing system may automatically forward the approved report to the relevant regulatory body upon approval by the CCO.

Various aspects of the disclosure have now been discussed in detail; however, the invention should not be understood as being limited to these aspects. It should also be appreciated that various modifications, adaptations, and alternative embodiments thereof may be made within the scope and spirit of the present invention.

What is claimed is:

1. A method of bi-directional communication to implement regulatory compliance monitoring and to be implemented using a computing system, the method including:
providing, via a first communication network, by the computing system, a graphical user interface (GUI) to a compliance monitor, the GUI providing the compliance monitor with options corresponding to various compliance-related information gathering and monitoring operations;
upon initiation by the compliance monitor, using the GUI, providing, by the computing system, via a second communication network that is the same as or different from the first communication network, to one or more employees under oversight by the compliance monitor, at least one request for compliance-related information, wherein the request includes a link to a questionnaire or other form;
storing, by the computing system, response information received from the one or more employees in a database;
upon receiving a request, at the computing system, from the compliance monitor, using the GUI and via the first communication network, generating a report based on the stored response information;
displaying the report, by the computing system, using the GUI and via the first communication network, to the compliance monitor, including offering at least one option to provide at least one comment or finding based on the report, to result in a modified report; and
forwarding, by the computing system, via the second communication network, the modified report to a designated employee among the one or more employees under the oversight of the compliance monitor, in the form of a link, wherein selecting the link enables the designated employee to view the modified report and to respond to the at least one comment or finding.

2. The method according to claim 1, further including:
monitoring, by the computing system, completion of the questionnaire or other form by the one or more employees under the oversight of the compliance monitor; and
making available, by the computing system, upon request by the compliance monitor, using the GUI via the first communication network, a status report on completion of the questionnaire or other form.

3. The method according to claim 1, further including:
providing, by the computing system, via the first communication network, a notification to the compliance monitor that a response to the modified report is available for review.

4. The method according to claim 1, further including:
configuring the GUI, by the computing system, to enable the compliance monitor with options to select among multiple types of information requests.

5. The method according to claim 1, further including:
configuring the GUI, by the computing system, to enable the compliance monitor to select among multiple types of information-based reports.

6. The method according to claim 1, further including:
configuring the GUI, by the computing system, to enable the compliance monitor to retrieve and view compliance-related documentation stored in the database.

7. The method according to claim 1, wherein the GUI provided to the compliance monitor by the computing system is configured with drop-down menus to provide the compliance monitor with one or more sub-options within selectable options.

8. The method according to claim 1, wherein the GUI provided to the compliance monitor by the computing system is configured with at least one button in a display portion associated with an employee or group of employees to enable the compliance monitor to obtain additional information regarding the employee or group of employees by selecting the at least one button associated with the employee or group of employees.

9. The method according to claim 8, wherein at least some additional information is provided to the compliance monitor by the computing system, using the GUI, in response to selection by the compliance monitor among a group of selectable options.

10. The method according to claim 9, wherein the group of selectable options includes types of compliance-related information, documents, or both.

11. The method according to claim 1, further including:
providing, by the computing system, in the GUI, a button that, upon selection by the compliance monitor, includes a drop-down menu action item to initiate an audit.

12. An apparatus to provide bi-directional communication to implement regulatory compliance monitoring, the apparatus comprising:
at least one processor;
at least one database communicatively coupled to the at least one processor;
one or more input/output (I/O) components communicatively coupled to the at least one processor; and
a non-transitory memory, communicatively coupled to the at least one processor, and having stored therein instructions for the implementation of operations including:
providing, via a first communication network, a graphical user interface (GUI) to a compliance monitor, the GUI providing the compliance monitor with options corresponding to various compliance-related information gathering and monitoring operations;
upon initiation by the compliance monitor, using the GUI, providing, via a second communication network that is the same as or different from the first communication network, to one or more employees under oversight by the compliance monitor, at least one request for compliance-related information, wherein the request includes a link to a questionnaire or other form;
storing response information received from the one or more employees in a database;
upon receiving a request from the compliance monitor, using the GUI and via the first communication network, generating a report based on the stored response information;
displaying the report, using the GUI and via the first communication network, to the compliance monitor, including offering at least one option to provide at least one comment or finding based on the report, to result in a modified report; and
forwarding, via the second communication network, the modified report to a designated employee among the one or more employees under the oversight of the compliance monitor, in the form of a link, wherein selecting the link enables the designated employee to view the modified report and to respond to the at least one comment or finding.

13. The apparatus according to claim 12, wherein the operations further include:
monitoring completion of the questionnaire or other form by the one or more employees under the oversight of the compliance monitor; and
making available, upon request by the compliance monitor, using the GUI via the first communication network, a status report on completion of the questionnaire or other form.

14. The apparatus according to claim 12, wherein the operations further include:
providing, via the first communication network, a notification to the compliance monitor that a response to the modified report is available for review.

15. The apparatus according to claim 12, wherein the operations further include configuring the GUI to enable the compliance monitor with options to select among multiple types of information requests.

16. The apparatus according to claim 12, wherein the operations further include configuring the GUI to enable the compliance monitor to select among multiple types of information-based reports.

17. The apparatus according to claim 12, wherein the operations further include configuring the GUI to enable the compliance monitor to retrieve and view compliance-related documentation stored in the database.

18. The apparatus according to claim 12, wherein the GUI provided to the compliance monitor is configured with drop-down menus to provide the compliance monitor with one or more sub-options within selectable options.

19. The apparatus according to claim 12, wherein the GUI provided to the compliance monitor is configured with at least one button in a display portion associated with an employee or group of employees to enable the compliance monitor to obtain additional information regarding the employee or group of employees by selecting the at least one button associated with the employee or group of employees.

20. The apparatus according to claim 19, wherein at least some additional information is provided to the compliance monitor, using the GUI, in response to selection by the compliance monitor among a group of selectable options.

21. The apparatus according to claim 20, wherein the group of selectable options includes types of compliance-related information, documents, or both.

22. The apparatus according to claim 12, wherein the operations further include providing, in the GUI, a button that, upon selection by the compliance monitor, includes a drop-down menu action item to initiate an audit.

23. A non-transitory computer-readable medium containing executable instructions recorded thereon that are designed to implement operations in a computing system, the operations including:
providing, via a first communication network, by the computing system, a graphical user interface (GUI) to a compliance monitor, the GUI providing the compliance monitor with options corresponding to various compliance-related information gathering and monitoring operations;
upon initiation by the compliance monitor, using the GUI, providing, by the computing system, via a second communication network that is the same as or different from the first communication network, to one or more employees under oversight by the compliance monitor, at least one request for compliance-related information, wherein the request includes a link to a questionnaire or other form;
storing, by the computing system, response information received from the one or more employees in a database;
upon receiving a request, at the computing system, from the compliance monitor, using the GUI and via the first communication network, generating a report based on the stored response information;
displaying the report, by the computing system, using the GUI and via the first communication network, to the compliance monitor, including offering at least one option to provide at least one comment or finding based on the report, to result in a modified report; and
forwarding, by the computing system, via the second communication network, the modified report to a designated employee among the one or more employees under the oversight of the compliance monitor, in the form of a link, wherein selecting the link enables the designated employee to view the modified report and to respond to the at least one comment or finding.

24. The medium according to claim 23, the operations further including:
monitoring, by the computing system, completion of the questionnaire or other form by the one or more employees under the oversight of the compliance monitor; and
making available, by the computing system, upon request by the compliance monitor, using the GUI via the first communication network, a status report on completion of the questionnaire or other form.

25. The medium according to claim 23, the operations further including:
providing, by the computing system, via the first communication network, a notification to the compliance monitor that a response to the modified report is available for review.

26. The medium according to claim 23, the operations further including configuring the GUI, by the computing system, to enable the compliance monitor with options to select among multiple types of information requests.

27. The medium according to claim 23, the operations further including configuring the GUI, by the computing system, to enable the compliance monitor to select among multiple types of information-based reports.

28. The medium according to claim 23, the operations further including configuring the GUI, by the computing system, to enable the compliance monitor to retrieve and view compliance-related documentation stored in the database.

29. The medium according to claim 23, wherein the GUI provided to the compliance monitor by the computing system is configured with drop-down menus to provide the compliance monitor with one or more sub-options within selectable options.

30. The medium according to claim 23, wherein the GUI provided to the compliance monitor by the computing system is configured with at least one button in a display portion associated with an employee or group of employees to enable the compliance monitor to obtain additional information regarding the employee or group of employees by selecting the at least one button associated with the employee or group of employees.

31. The medium according to claim 30, wherein at least some additional information is provided to the compliance monitor by the computing system, using the GUI, in response to selection by the compliance monitor among a group of selectable options.

32. The medium according to claim 31, wherein the group of selectable options includes types of compliance-related information, documents, or both.

33. The medium according to claim 23, the operations further including the computing system providing, in the GUI, a button that, upon selection by the compliance monitor, includes a drop-down menu action item to initiate an audit.
